(19) United States
(12) Patent Application Publication
(10) Pub. No.: US 2019/0034195 A1
(43) Pub. Date: Jan. 31, 2019

(54) SYSTEMS AND METHODS FOR PROVIDING PATCHABLE ROM FIRMWARE

(71) Applicant: QUALCOMM INCORPORATED, SAN DIEGO, CA (US)

(72) Inventors: EUGEN PIRVU, MISSION VIEJO, CA (US); DHAMIM PACKER ALI, SAN DIEGO, CA (US); DHAVAL PATEL, SAN DIEGO, CA (US); BHARGAV GURAPPADI, SAN DIEGO, CA (US)

(21) Appl. No.: 15/660,429

(22) Filed: Jul. 26, 2017

(51) Int. Cl. G06F 9/445; G06F 12/06; G06F 15/78

(52) U.S. Cl. CPC G06F 8/66; G06F 2212/205; G06F 15/7807; G06F 12/0638

(57) ABSTRACT

Systems, methods, and computer programs are disclosed for providing patchable read only memory (ROM) firmware. One method comprises receiving source code to be used as input for building a read only memory (ROM) image stored on a system on chip (SoC). One or more of a plurality of ROM functions in the source code to be made patchable are identified. The source code for the one or more of the plurality of ROM functions to be made patchable is modified by generating and inserting patching code into the corresponding source code. The patching code comprises a link to a fixed location in random access memory (RAM) for calling the corresponding function.

### DESCRIPTION OF THE RELATED ART

Manufacturers of chips used in various types of computing devices (e.g., Internet-of-things (IoT) devices, wearable devices, cellular telephones, smart phones, tablet computers, portable game consoles) are increasingly using read only memory (ROM) to store a firmware image. For example, all or a portion of so-called “mission mode code” for the chip may stored in ROM. The use of ROM firmware may enable chip manufactures to lower costs and address security concerns. As known in the art, ROM is substantially cheaper than equivalent alternatives (e.g., static random access memory (SRAM)) from cost, die size, and power perspectives. Furthermore, ROM improves security because it is tamper proof.

However, because the code is stored in ROM, it is not possible to be modified to fix potential bugs or to offer more configurability after design tapeout and commercialization. One solution to these constraints is the use of one-time programmable (OTP) fuses. However, this solution is limited to patching a relatively small number of instructions and also comes at the expense of factory process and rollout overhead for the chip manufacturers.

Accordingly, there is a need for improved systems and methods for providing patchable ROM firmware.

### SUMMARY OF THE DISCLOSURE

Systems, methods, and computer programs are disclosed for providing patchable read only memory (ROM) firmware. One method comprises receiving source code to be used as input for building a read only memory (ROM) image stored on a system on chip (SoC). One or more of a plurality of ROM functions in the source code to be made patchable are identified. The source code for the one or more of the plurality of ROM functions to be made patchable is modified by generating and inserting patching code into the corresponding source code. The patching code comprises a link to a fixed location in random access memory (RAM) for calling the corresponding function.

Another embodiment is a system on chip (SoC) comprising a processor, a read only memory (ROM), and a random access memory (RAM). The processor is configured to execute a firmware image stored on the ROM. The firmware image comprises one or more patchable ROM functions. Each patchable ROM function comprises a link to a fixed location in RAM for calling the corresponding function.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a system for building patchable read only memory (ROM) firmware for a system-on-chip (SoC).

FIG. 2 is a block diagram illustrating the architecture, functionality, and/or operation of the patching framework in the system of FIG. 1.

FIG. 3 illustrates an exemplary embodiment of a method for generating patchable code for an exemplary ROM function.

FIG. 4 illustrates the indirection table of FIG. 3 modified to call patched RAM code for the exemplary ROM function.

FIG. 5 is a block/flow diagram illustrating an embodiment of a code-based indirection table in an initial configuration.

FIG. 6 is a block/flow diagram illustrating an embodiment of a data-based indirection table in an initial configuration.

FIG. 7 illustrates the code-based indirection table of FIG. 5 in a patched configuration.

FIG. 8 illustrates the data-based indirection table of FIG. 6 in a patched configuration.

FIG. 9 is a flow chart illustrating a first aspect of an exemplary embodiment of a method implemented in the build system of FIG. 1 for building a patchable ROM image.

FIG. 10 is a flow chart illustrating a second aspect of an exemplary embodiment of a method implemented in the build system of FIG. 1 for building a patchable ROM image.

FIG. 11 is a block diagram of an exemplary embodiment of a portable computing device for incorporating patchable ROM firmware build using the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”), fourth generation (“4G”), fifth generation (“5G”) and other wireless technology, greater bandwidth availability has enabled more portable computing devices with a greater variety of wireless capabilities.

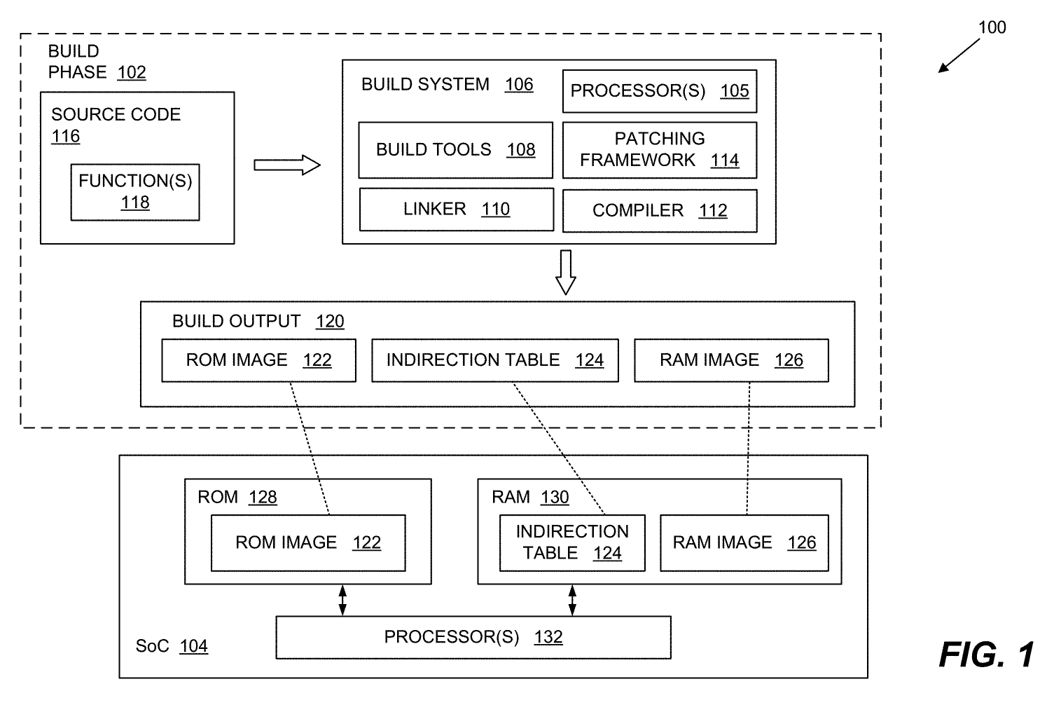

FIG. 1 illustrates a system environment 100 for building patchable read only memory (ROM) firmware for a system-on-chip (SoC) 104. The system environment 100 involves a build phase 102 comprising a specially-configured build system 106. As known in the art, a build system may comprise various tools for the creation of a software build and various associated processes, such as, compiling source code into binary code, packaging binary code, and running automated tests. In this regard, the build system 106 comprises a processor 105 for executing various build tools 108, a compiler 112, and a linker 110. These aspects of the build system 106 may be similar to those components incorporated in existing build systems, such as, for example, the open source software construction tool “SCons” and other build systems, tools, utilities, etc. As illustrated in the embodiment of FIG. 1, the build system 106 further incorporates a specially-configured patching framework 114, which generally comprises the logic and/or functionality for building patchable ROM firmware for the SoC 102.

It should be appreciated that the patching framework 114 advantageously provides a scalable, processor/compiler-independent patching infrastructure. The patching framework 114 enables function-level granularity. The patching framework is scalable to the size of the ROM image. Furthermore, the patching solution is not tied to compiler-generated code and, therefore, is processor/compiler agnostic.

During the build phase 102, the build system 106 receives source code 116 to be used as input for building a read only memory (ROM) image to be stored on the SoC 102. The source code 116 may comprise any desirable computing language, including for example, object oriented languages such as C, C++, etc. The source code 116 may comprise a plurality of functions 118, which may include one or more calls to other functions 118. As described below in more detail, the patching framework 114 may be configured to identify one or more functions 118 in the source code 116 to be made patchable (referred to as “patchable functions”). For each patchable function, the patching framework 114 is configured to modify, prior to building the ROM image 122, the corresponding source code by generating and inserting patching code into the corresponding function 118. The patching code is operatively coupled to an indirection table 124 to be stored in random access memory (RAM). In this regard, the patching code comprises a link, instruction, call, etc. to a fixed RAM location (e.g., an entry in indirection table 124) that is used during operation to selectively control whether the patchable function 118 will be called from ROM 128 or RAM 130. Data stored in and/or functionality associated with the fixed RAM location may be initialized such that the code associated with the patchable function 118 is called from ROM 128 (i.e., no patch is applied). However, should the ROM code need to be patched, updated, etc., the data stored in and/or the functionality associated with the fixed RAM location may be updated such that patched code stored in RAM 130 is called instead of the ROM code.

As further illustrated in FIG. 1, it should be appreciated that the output 120 of the build system 106 may comprise the ROM image 122, a RAM image 126, and the indirection table 124. In this regard, the firmware image for SoC 102 may be split between ROM 128 and RAM 130. In other embodiments, the firmware image may initially be stored in ROM 138 and, as patching occurs, those portions may be moved to RAM 130. Regardless the embodiment, as described above, the initial ROM image 122 is built based on the source code 116 which has been modified by the patching framework 114 with the patching code injected into the corresponding patchable functions 118.

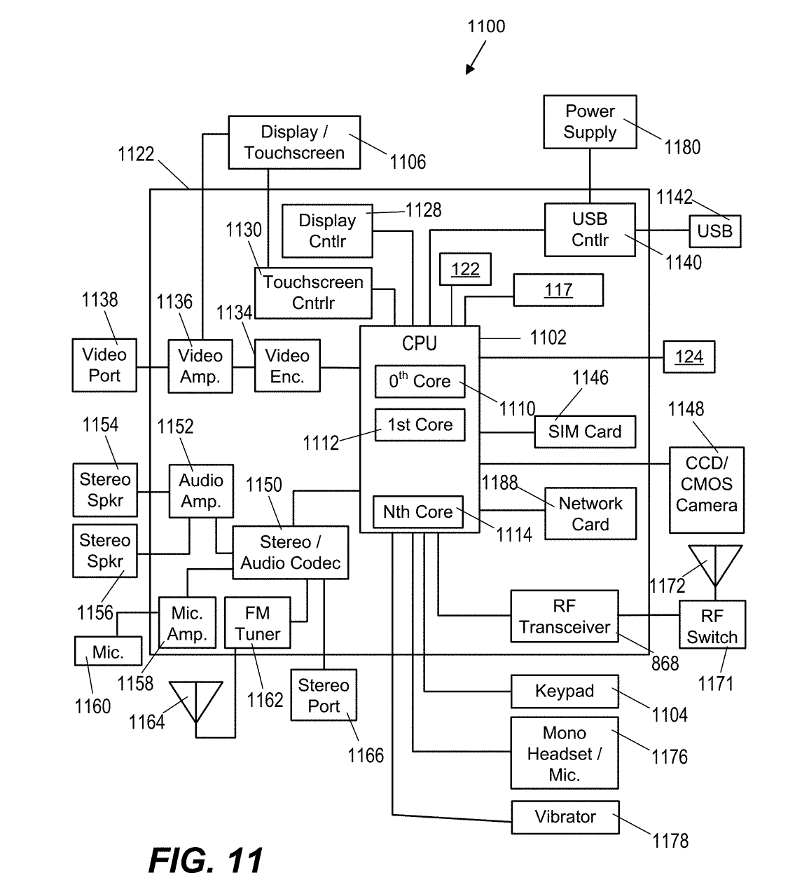

It should be appreciated that the patchable ROM image 122, indirection table 124, and/or RAM image 126 generated by the build system 106 may be stored on various types of integrated circuits, chips, embedded systems, SoCs, etc. (which comprise one or more processor(s) 132), and may be incorporated into various types of computing devices (e.g., Internet-of-things (IoT) devices, wearable devices, cellular telephones, smart phones, tablet computers, portable game consoles, etc. An exemplary implementation of the SoC 102 incorporated in a portable computing device 1100 is described below in connection with FIG. 11.

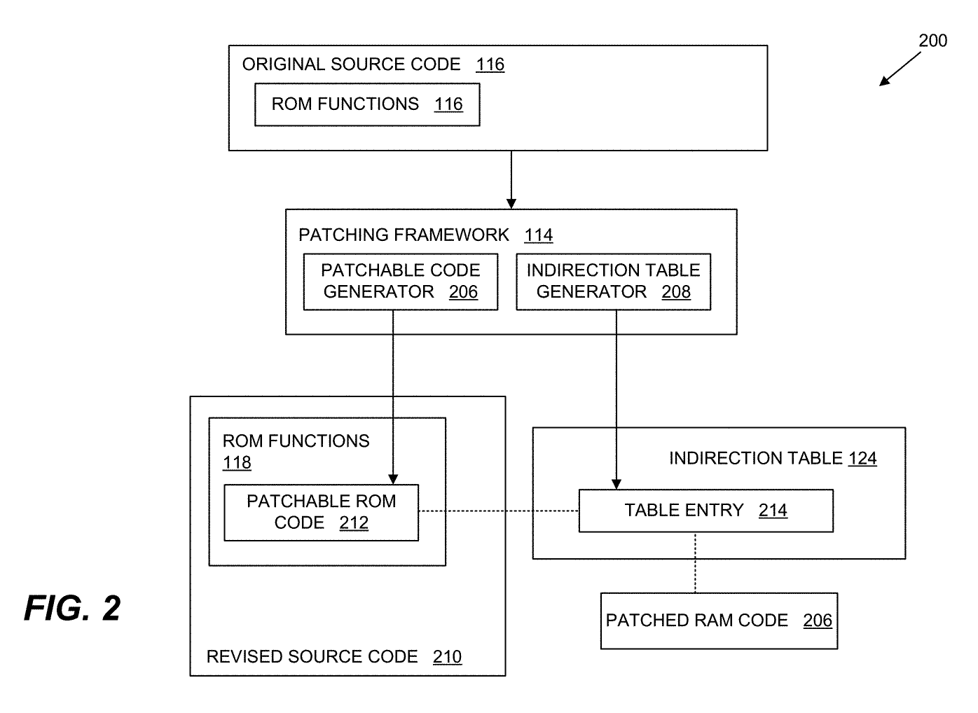

Having generally described the patching framework 114, FIG. 2 illustrates the architecture, functionality, and/or operation of an exemplary patching framework 114. In this embodiment, the patching framework 114 comprises two main components: a patchable code generator module 206; and an indirection table generator module 208. The patchable code generator module 206 receives original ROM source code 116 and identifies one or more functions 118 to be made patchable. For each patchable function 118, the patchable code generator module 206 automatically generates and injects patchable ROM code 212 to produce revised ROM source code 210 for the patchable function 118. As mentioned above, the patchable ROM code 212 may comprise a link, instruction, call, etc. to a corresponding entry 214 in the indirection table 124 that is used during operation to selectively control whether the patchable function 118 will be called from ROM 128 or patched RAM code 206.

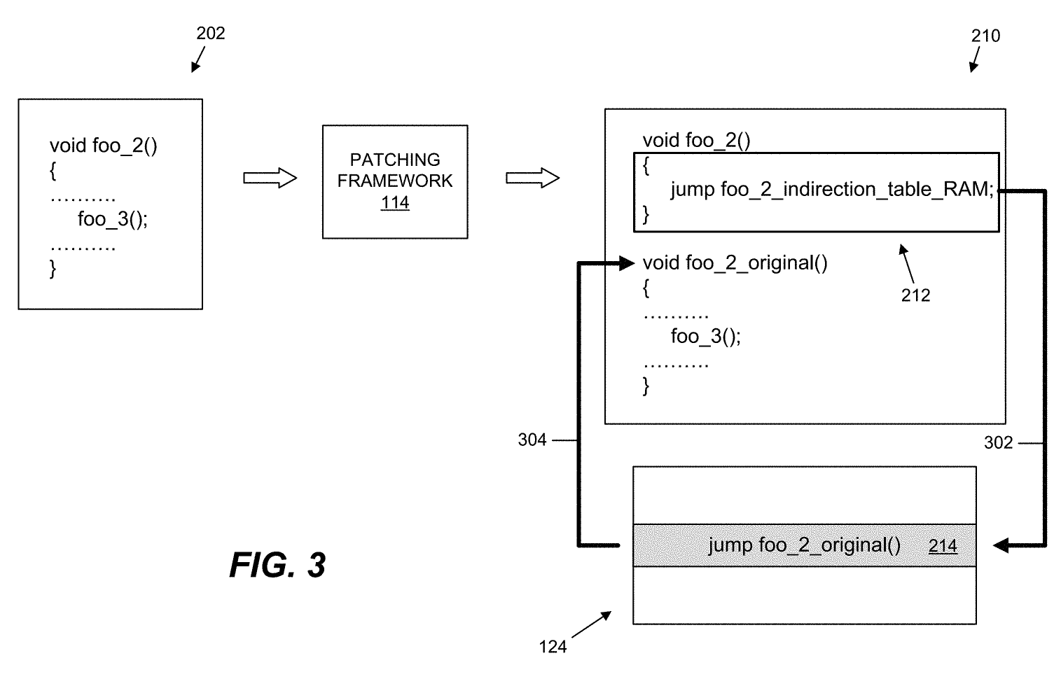

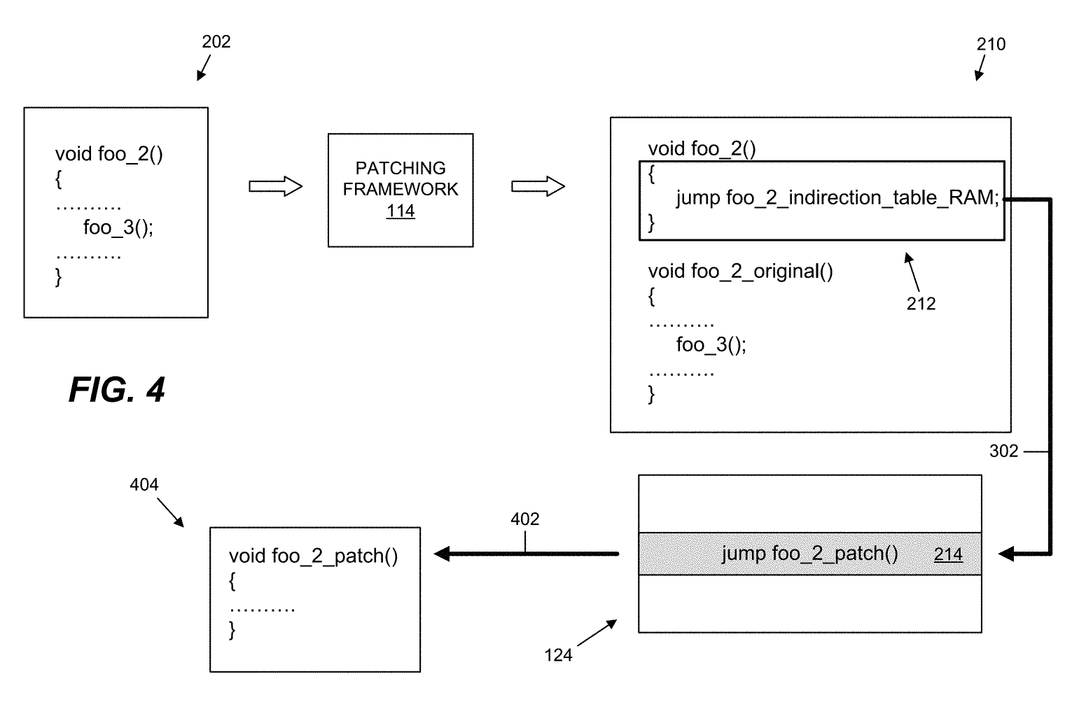

FIG. 3 illustrates an embodiment of patchable ROM code 212 for an illustrative function “foo_2( )”. In this embodiment, the patchable ROM code 212 comprises a jump instruction (reference numeral 302) to an entry 214 in the indirection table 124. The instruction “jump foo_2_indirection table RAM” is injected prior to the function code. The entry 214 may be initially configured with another jump instruction (reference numeral 304) to the original foo_2( ) function. FIG. 4 illustrates the entry 214 in the indirection table 124 of FIG. 3 after a patch has been applied. The original jump instruction (“jump foo_2_original( )”) to “void foo_2_original” (reference numeral 304) is replaced with a new jump instruction (“jump foo_2_patch( )”) to patched RAM code 404 (reference numeral 402).

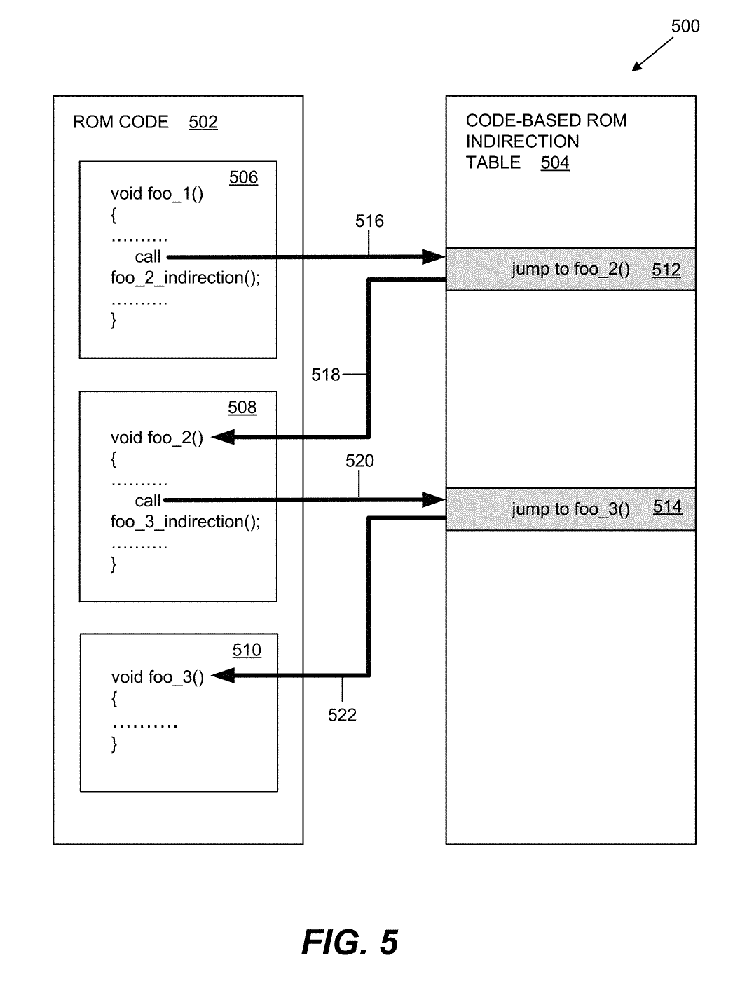

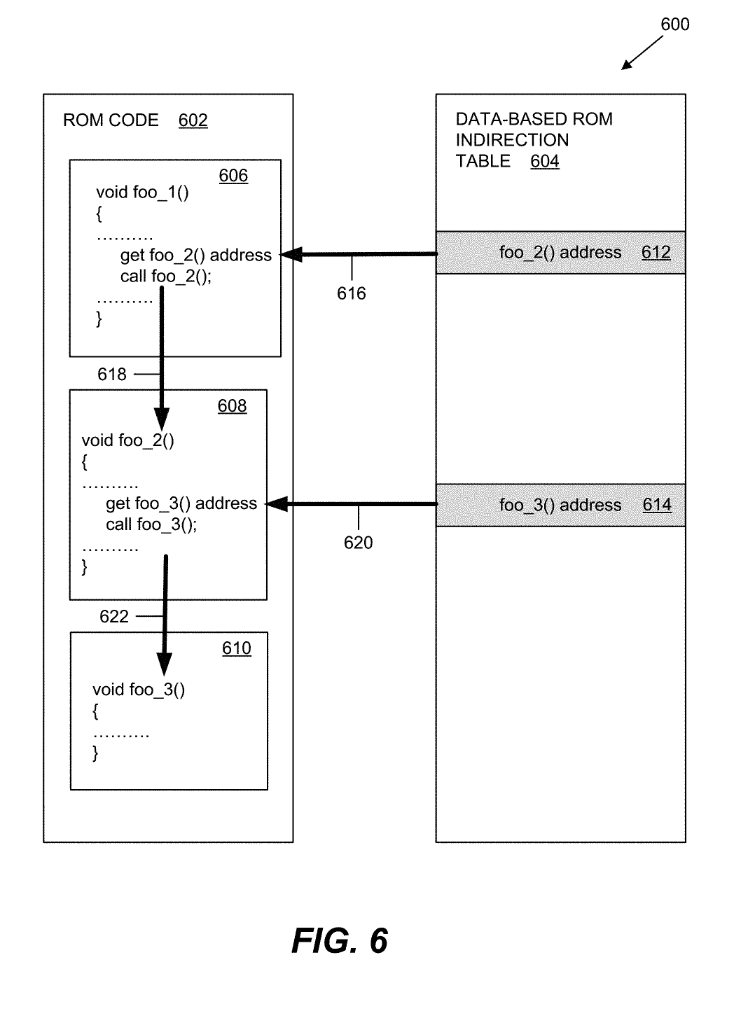

It should be appreciated that the patchable ROM code 212 and the indirection table 124 may be implemented in various ways to control whether the original ROM code is executed or, when a patch is applied, the patched RAM code is executed. FIGS. 5 & 7 illustrate an example of a code-based implementation. FIGS. 6 & 8 illustrate an example of a data-based implementation.

FIG. 5 illustrates an initial configuration 500 of a code-based indirection table 504 and an exemplary ROM code 502. ROM code 502 comprises a first function 506 (“foo_1( )”), a second function 508 (“foo_2( )”), and third function 510 (“foo _3( )). As illustrated by reference numerals 516 and 518, the first function 506 comprises a call (”call foo_2_indirection( )) to the second function 508 via an entry 512 in code-based indirection table 504. In the initial configuration, the entry 512 comprises a jump instruction (“jump to foo_2( )”) to the second function 508 (reference numeral 518). As illustrated by reference numerals 520 and 522, the second function 508 comprises a call (“call foo_3_indirection( )”) to the third function 510 via an entry 514 in code-based indirection table 504. In the initial configuration, the entry 514 comprises a jump instruction (“jump to foo_3( )”) to the third function 510 (reference numeral 520).

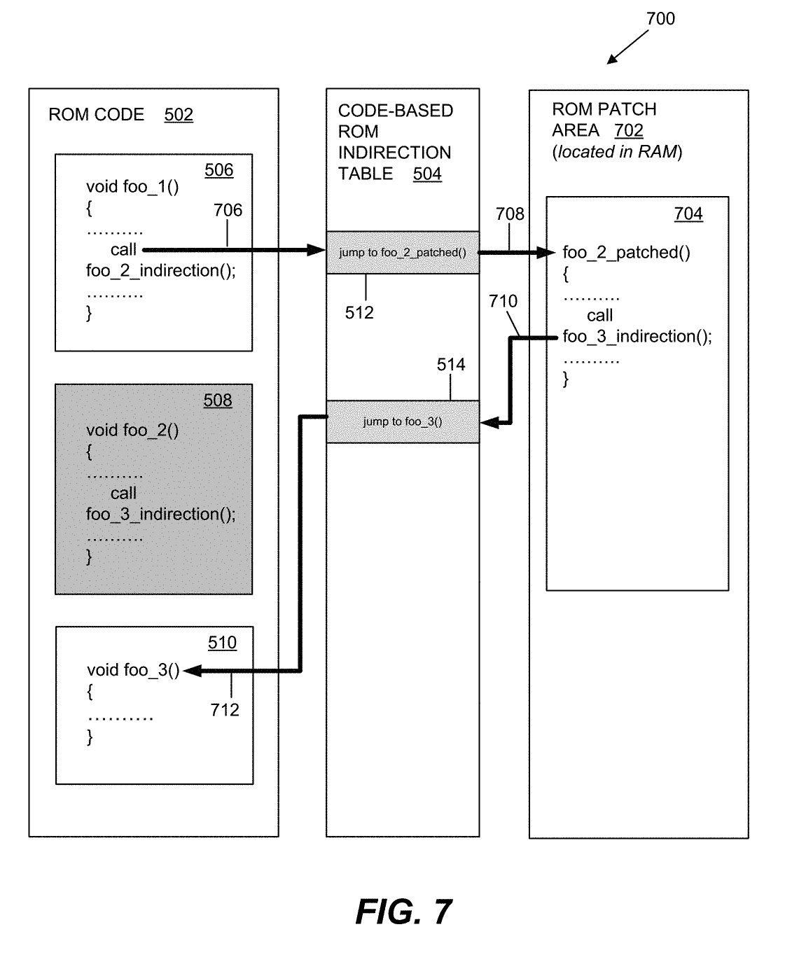

FIG. 7 illustrates the code-based indirection table 504 after the second function 508 has been patched. In the patched configuration 700, a patched version 704 of the second function 508 is stored in a patch area 702 located in RAM 130. The entry 512 in code-based indirection table 504 is updated with a jump instruction (“jump to foo_2_patched( )”) to the patched version 704 (reference numeral 708). In this manner, the patched version 704 is executed instead of the original second function 508.

FIG. 6 illustrates an initial configuration 600 of a data-based indirection table 604 and an exemplary ROM code 602. ROM code 602 comprises a first function 606 (“foo_1( )”), a second function 608 (“foo_2( )”), and third function 610 (“foo_3( )”). As illustrated by reference numerals 616 and 618, the first function 606 comprises a “get address” call for requesting the address stored in entry 612. In the initial configuration, the entry 612 returns the ROM address “foo_2_address” (reference numeral 616). In response, the first function 606 calls the second function 608 from ROM code 602. The second function 608 calls the third function 610 in a similar manner via entry 614 (reference numerals 620 and 622).

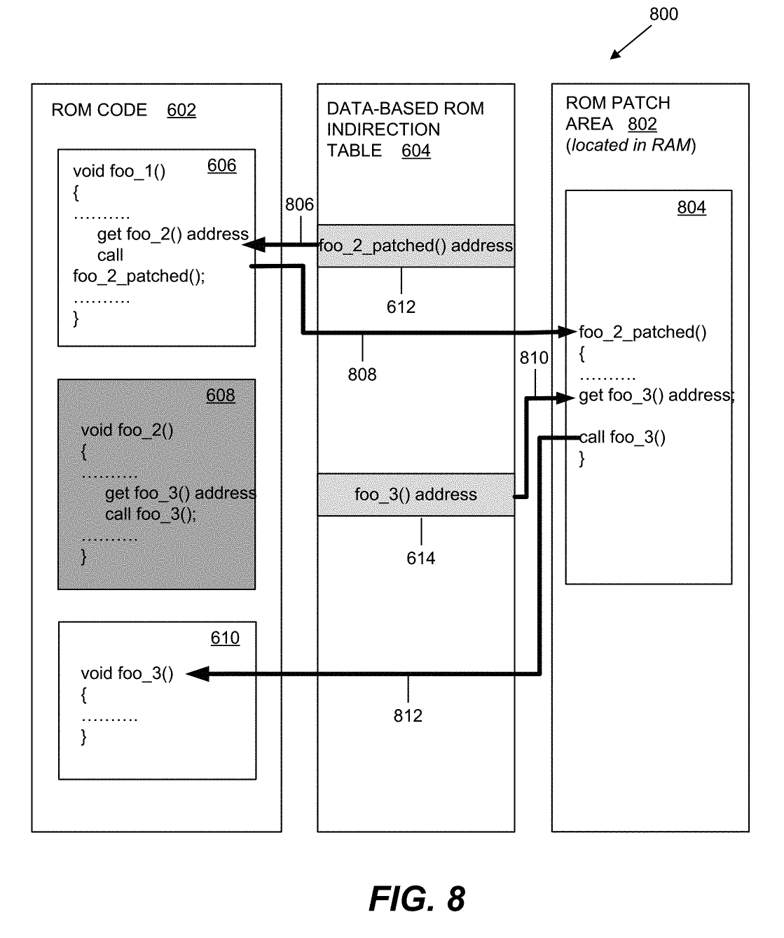

FIG. 8 illustrates the data-based indirection table 604 after the second function 608 has been patched. In the patched configuration 800, a patched version 804 of the second function 608 is stored in a patch area 802 located in RAM 130. The entry 612 is updated to return the RAM address where the patched version 804 is located (reference numeral 806). In response, the first function 606 calls the patched version 804 in RAM 130 instead of the original second function 608 stored in ROM.

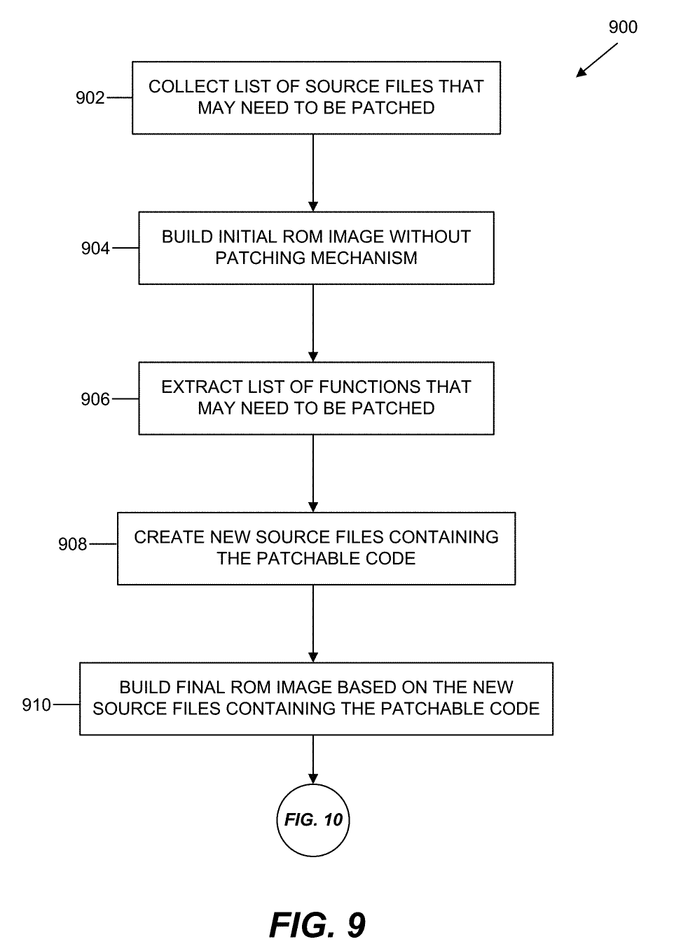

FIGS. 9 & 10 illustrate an exemplary embodiment of a method 900 implemented in the build system 106 for building a patchable ROM image. At block 902, the build system 106 collects a list of files associated with the source code 116, which may need to be patched. At block 904, the build system 106 builds an initial ROM image without employing the patching framework 114. At block 906, a list of patchable functions 118 may be extracted using, for example, symbol file(s), map files comprising a text file generated by the linker 110, or other files generated by the compiler 112 and/or the linker 110 (e.g, obj files, the elf file, etc.). At block 908, the patching framework 114 may create new source files containing the patchable code, as described above. At block 910, the build system 106 may build the final ROM image 122 based on the new source files including the patchable code.

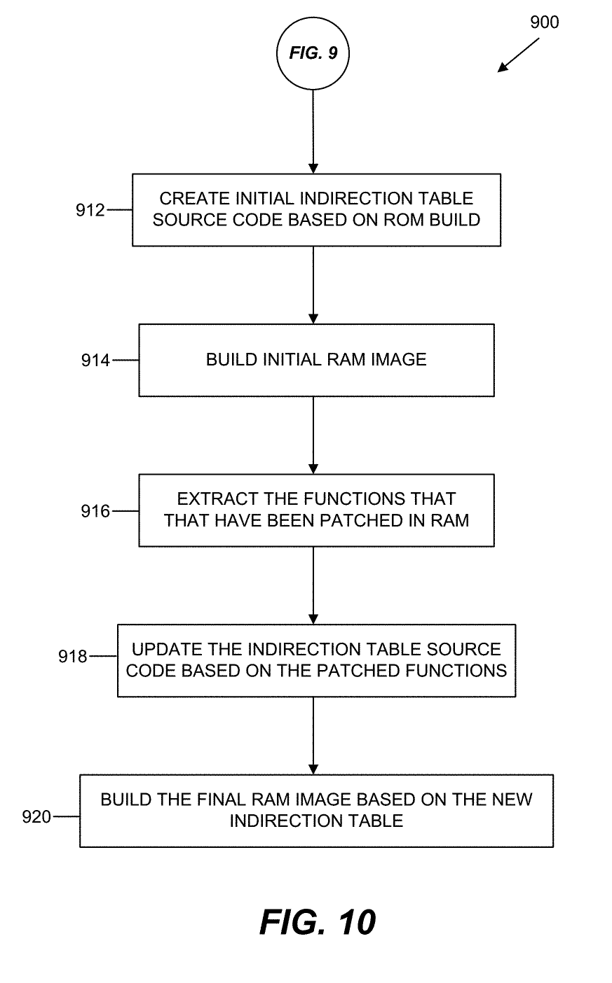

FIG. 10 illustrates an exemplary RAM build flow that may follow the ROM build flow illustrated in FIG. 9. At block 912, the build system 106 creates an initial indirection table 124 source code based on the ROM build metadata. The ROM build metadata comprises data collected and used for creating the patchable code and the indirection table 124 (e.g., function names, function addresses in ROM, patched function addresses in RAM, etc.). At block 914, the build system 106 builds an initial RAM image 126. At block 916, the build system 106 extracts the functions 118 that have been patched in RAM 130. At block 918, the indirection table 124 may be updated based on the patched functions. At block 920, the build system 106 builds a final RAM image based on the updated indirection table 124.

As mentioned above, the SoC 102 may be incorporated into any desirable computing system. FIG. 11 illustrates the system 100 incorporated in an exemplary portable computing device (PCD) 1100. It will be readily appreciated that certain components of the system 100 may be included on the SoC 1122 while other components may be external components coupled to the SoC 1122. The SoC 1122 may include a multicore CPU 1102. The multicore CPU 1102 may include a zeroth core 1110, a first core 1112, and an Nth core 1114. One of the cores may comprise, for example, a graphics processing unit (GPU) with one or more of the others comprising the CPU 1102.

A display controller 1128 and a touch screen controller 1130 may be coupled to the CPU 1102. In turn, the touch screen display 1106 external to the on-chip system 1122 may be coupled to the display controller 1128 and the touch screen controller 1130.

FIG. 11 further shows that a video encoder 1134, e.g., a phase alternating line (PAL) encoder, a sequential color a memoire (SECAM) encoder, or a national television system(s) committee (NTSC) encoder, is coupled to the multicore CPU 1102. Further, a video amplifier 1136 is coupled to the video encoder 1134 and the touch screen display 1106. Also, a video port 1138 is coupled to the video amplifier 1136. As shown in FIG. 11, a universal serial bus (USB) controller 1140 is coupled to the multicore CPU 1102. Also, a USB port 1142 is coupled to the USB controller 1140.

Further, as shown in FIG. 11, a digital camera 1148 may be coupled to the multicore CPU 1102. In an exemplary aspect, the digital camera 1148 is a charge-coupled device (CCD) camera or a complementary metal-oxide semiconductor (CMOS) camera.

As further illustrated in FIG. 11, a stereo audio coder-decoder (CODEC) 1150 may be coupled to the multicore CPU 1102. Moreover, an audio amplifier 1152 may coupled to the stereo audio CODEC 1150. In an exemplary aspect, a first stereo speaker 1154 and a second stereo speaker 1156 are coupled to the audio amplifier 1152. FIG. 11 shows that a microphone amplifier 1158 may be also coupled to the stereo audio CODEC 1150. Additionally, a microphone 1160 may be coupled to the microphone amplifier 1158. In a particular aspect, a frequency modulation (FM) radio tuner 1162 may be coupled to the stereo audio CODEC 1150. Also, an FM antenna 1164 is coupled to the FM radio tuner 1162. Further, stereo headphones 1166 may be coupled to the stereo audio CODEC 1150.

FIG. 11 further illustrates that a radio frequency (RF) transceiver 1168 may be coupled to the multicore CPU 1102. An RF switch 1170 may be coupled to the RF transceiver 1168 and an RF antenna 1172. A keypad 1104 may be coupled to the multicore CPU 1102. Also, a mono headset with a microphone 1176 may be coupled to the multicore CPU 1102. Further, a vibrator device [ ]8 may be coupled to the multicore CPU 1102.

FIG. 11 also shows that a power supply 1180 may be coupled to the on-chip system 1122. In a particular aspect, the power supply 1180 is a direct current (DC) power supply that provides power to the various components of the PCD 1100 that require power. Further, in a particular aspect, the power supply is a rechargeable DC battery or a DC power supply that is derived from an alternating current (AC) to DC transformer that is connected to an AC power source.

FIG. 11 further indicates that the PCD 1100 may also include a network card 1188 that may be used to access a data network, e.g., a local area network, a personal area network, or any other network. The network card 1188 may be a Bluetooth network card, a WiFi network card, a personal area network (PAN) card, a personal area network ultra-low-power technology (PeANUT) network card, a television/cable/satellite tuner, or any other network card well known in the art. Further, the network card 1188 may be incorporated into a chip, i.e., the network card 1188 may be a full solution in a chip, and may not be a separate network card 1188.

As depicted in FIG. 11, the touch screen display 1106, the video port 1138, the USB port 1142, the camera 1148, the first stereo speaker 1154, the second stereo speaker 1156, the microphone 1160, the FM antenna 1164, the stereo headphones 1166, the RF switch 1170, the RF antenna 1172, the keypad 1174, the mono headset 1176, the vibrator 1178, and the power supply 1180 may be external to the on-chip system 1122.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for providing patchable read only memory (ROM) firmware, the method comprising:
receiving source code to be used as input for building a read only memory (ROM) image stored on a system on chip (SoC);
identifying one or more of a plurality of ROM functions in the source code to be made patchable; and
modifying the source code for the one or more of the plurality of ROM functions to be made patchable by generating and inserting patching code into the corresponding source code, the patching code comprising a link to a fixed location in random access memory (RAM) for calling the corresponding function.

2. The method of claim 1, further comprising: building the ROM image based on the modified source code comprising the patching code.

3. The method of claim 1, wherein the fixed RAM location comprises an entry in an indirection table.

4. The method of claim 3, wherein the entry is initialized with a jump instruction to call the corresponding ROM function.

5. The method of claim 3, wherein the entry is updated with a jump instruction to call patched RAM code.

6. The method of claim 3, wherein the entry identifies a ROM address for executing the corresponding ROM function.

7. The method of claim 3, wherein the entry is updated to identify a RAM address for executing patched RAM code.

8. A system for providing patchable read only memory (ROM) firmware, the system comprising:
means for receiving source code to be used as input for building a read only memory (ROM) image stored on a system on chip (SoC);
means for identifying one or more of a plurality of ROM functions in the source code to be made patchable; and
means for modifying the source code for the one or more of the plurality of ROM functions to be made patchable by generating and inserting patching code into the corresponding source code, the patching code comprising a link to a fixed location in random access memory (RAM) for calling the corresponding function.

9. The system of claim 8, further comprising: means for building the ROM image based on the modified source code comprising the patching code.

10. The system of claim 9, wherein the means for building the ROM image comprises a compiler and a linker.

11. The system of claim 8, wherein the fixed RANI location comprises an entry in an indirection table.

12. The system of claim 11, wherein the entry is initialized with a jump instruction to call the corresponding ROM function.

13. The system of claim 11, wherein the entry is updated with a jump instruction to call patched RAM code.

14. The system of claim 11, wherein the entry identifies a ROM address for executing the corresponding ROM function.

15. The system of claim 11, wherein the entry is updated to identify a RAM address for executing patched RAM code.

16. A system comprising:
a system on chip (SoC) comprising a processor, a read only memory (ROM), and a random access memory (RAM), the processor configured to execute a firmware image stored on the ROM;
the firmware image comprising one or more patchable ROM functions, each patchable ROM function comprising a link to a fixed location in RAM for calling the corresponding function.

17. The system of claim 16, wherein the fixed RANI location comprises an entry in an indirection table.

18. The system of claim 17, wherein the entry is initialized with a jump instruction to call the corresponding patchable ROM function.

19. The system of claim 17, wherein the entry is updated with a jump instruction to call patched code stored in the RAM.

20. The system of claim 17, wherein the entry identifies a ROM address for executing the corresponding patchable ROM function.

21. The system of claim 17, wherein the entry is updated to identify a RAM address for executing patched RAM code.

22. The system of claim 16, wherein the SoC is incorporated in a portable computing device.

23. The system of 22, wherein the portable computing device comprises a smartphone.

24. The system of claim 16, wherein the SoC is incorporated in an Internet-of-things (IoT) device.

25. A computer program embodied in a computer readable medium and executed by a processor for building patchable read only memory (ROM) firmware, the computer program comprising logic configured to:
receive source code to be used as input for building a read only memory (ROM) image stored on a system on chip (SoC);
identify one or more of a plurality of ROM functions in the source code to be made patchable; and
modify the source code for the one or more of the plurality of ROM functions to be made patchable by generating and inserting patching code into the corresponding source code, the patching code comprising a link to a fixed location in random access memory (RAM) for calling the corresponding function.

26. The computer program of claim 25, further comprising a compiler and a linker for building the ROM image based on the modified source code comprising the patching code.

27. The computer program of claim 25, wherein the fixed RAM location comprises an entry in an indirection table.

28. The computer program of claim 27, wherein the entry is initialized with a jump instruction to call the corresponding ROM function.

29. The computer program of claim 27, wherein the entry is updated with a jump instruction to call patched RAM code.

30. The computer program of claim 27, wherein the entry selectively identifies a ROM address for executing the corresponding ROM function and a RAM address for executing patched RAM code.
